(19) United States
(12) Patent Application Publication
(10) Pub. No.: US 2014/0201624 A1
(43) Pub. Date: Jul. 17, 2014

(54) SENTIMENTAL CARD SELECTION, CREATION AND PROCESSING APPLICATION

(71) Applicant: FELT LLC, Telluride, CO (US)

(72) Inventors: Andrew Clark, Lookout Mtn., GA (US); Tomer Alpert, Telluride, CO (US); David Littlejohn, Chattanooga, TN (US)

(73) Assignee: Felt LLC, Teluride, CO (US)

(21) Appl. No.: 13/874,841

(22) Filed: May 1, 2013

Related U.S. Application Data
(60) Provisional application No. 61/751,590, filed on Jan. 11, 2013.

(51) Int. Cl. G06F 17/21

(52) U.S. Cl. CPC G06F 17/211
USPC 715/243

(57) ABSTRACT

Certain embodiments of the present application allow a user to preview a plurality of cards on a portable computing device, select a card from the plurality of cards, and modify the selected card. One example method of operation may include accessing a customizable data input templates stored in memory, selecting one of the customizable data input templates, inputting data to incorporate into the selected customizable data input template and transmitting the data to the remote server to be saved. The changes may be presented to the user in a preview with the inputted data overlaid on the predefined area of the customizable data input template, the preview may permit an acceptance option to finalize or reject the customizable data input template. The finalized customizable data input template may be saved as an acceptance message is received.

### CROSS-REFERENCE TO RELATED APPLICATIONS

The present application claims priority to earlier filed provisional patent application No. 61/751,590, filed on Jan. 11, 2013, entitled “CARD SELECTION PROCESS AND APPARATUS”, the entire contents of which are hereby incorporated by reference in its entirety.

### FIELD

The present application relates to card selection and, more particularly, to selecting and creating sentimental cards digitally on a computing application.

### BACKGROUND

For a user to create a greeting card (hereinafter “card”), the user may access a variety of websites or applications. However, such applications or websites may not be convenient when a user is utilizing his or her portable computing device, such as an iPad®, iPod®, Kindle Fire®, etc. Thus, a computing application that allows the user to seamlessly select a card, customize the card, and pay for the card may be beneficial.

### SUMMARY

Certain embodiments of the present application may provide solutions to the problems and needs in the art that have not yet been fully identified, appreciated, or solved by current card selection applications. For example, one embodiment of the present application allows the user to preview a plurality of cards on his or her portable computing device, select a card from the plurality of cards, and modify the selected card through a seamless process.

One example method of operation may include accessing a plurality of customizable data input templates stored in memory at a remote server, selecting one of the plurality of customizable data input templates, inputting data to incorporate into the selected customizable data input template, transmitting the data to the remote server, saving the inputted data as a predetermined data file type and inserting the inputted data within a predefined area of the customizable data input template, generating a preview of the selected customizable input template with the inputted data overlaid on the predefined area of the customizable data input template, the preview permitting an acceptance option to finalize or reject the customizable data input template; and saving the finalized customizable data input template an acceptance message is received.

Another example embodiment may include an apparatus that includes a processor configured to access a plurality of customizable data input templates stored in memory at a remote server, select one of the plurality of customizable data input templates, input data to incorporate into the selected customizable data input template, a transmitter configured to transmit the data to the remote server, a memory configured to save the inputted data as a predetermined data file type, and the processor is further configured to insert the inputted data within a predefined area of the customizable data input template, and generate a preview of the selected customizable input template with the inputted data overlaid on the predefined area of the customizable data input template, the preview permitting an acceptance option to finalize or reject the customizable data input template, and save the finalized customizable data input template an acceptance message is received.

### BRIEF DESCRIPTION OF THE DRAWINGS

In order for the advantages of certain embodiments of the application to be readily understood, a more particular description of the application briefly described above will be rendered by reference to specific embodiments that are illustrated in the appended drawings. While it should be understood that these drawings depict only typical embodiments of the application and are not therefore to be considered to be limiting of its scope, the application will be described and explained with additional specificity and detail through the use of the accompanying drawings, in which:

FIG. 1 is a flow diagram illustrating a process for selecting and creating cards, according to an embodiment of the present application.

FIG. 2 illustrates a flow diagram illustrating a process for displaying one or more cards, according to one embodiment of the present application.

FIG. 3 illustrates a flow diagram illustrating a process for checking out a card, according to one embodiment of the present application.

FIG. 4 illustrates a block diagram illustrating a card selection system, according to an embodiment of the present application.

FIG. 5 is a block diagram illustrating a card selection system 300, according to an embodiment of the present application.

FIG. 6 is a system communication diagram that illustrates the communication signaling that may be used in accordance with an example method of operation according to an embodiment of the present application.

FIG. 7 illustrates an example screen shot of a user interface of the card generation application according to an embodiment of the present application.

FIG. 8 illustrates another example screen shot of a user interface of the card generation application according to an embodiment of the present application.

FIG. 9 illustrates example screen shots of a user interface for data input of the card generation application according to an embodiment of the present application.

FIG. 10 illustrates an example screen shot of a user interface for data overlay of the card generation application according to an embodiment of the present application.

FIG. 11 illustrates another example screen shot of a user interface for finalizing a card of the card application according to an embodiment of the present application.

FIG. 12A illustrates a flow diagram of an example method of operation according to an embodiment of the present application.

FIG. 12B illustrates a logic diagram of an example method of operation according to an embodiment of the present application.

FIG. 13 illustrates an example system configured to perform an example method of operation according to an example embodiment.

FIG. 14 illustrates an example network entity device configured to store instructions, software, and corresponding hardware for executing the same, according to example embodiments of the present application.

### DETAILED DESCRIPTION OF THE EMBODIMENTS

Certain embodiments of the present application allow the user to preview a plurality of cards on his or her portable computing device, select a card from the plurality of cards, and modify the selected card through a seamless process.

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present application, the application may be applied to many types of network data, such as, packet, frame, datagram, etc. For purposes of this application, the term “message” also includes packet, frame, datagram, and any equivalents thereof. Furthermore, while certain types of messages and signaling are depicted in exemplary embodiments of the application, the application is not limited to a certain type of message, and the application is not limited to a certain type of signaling.

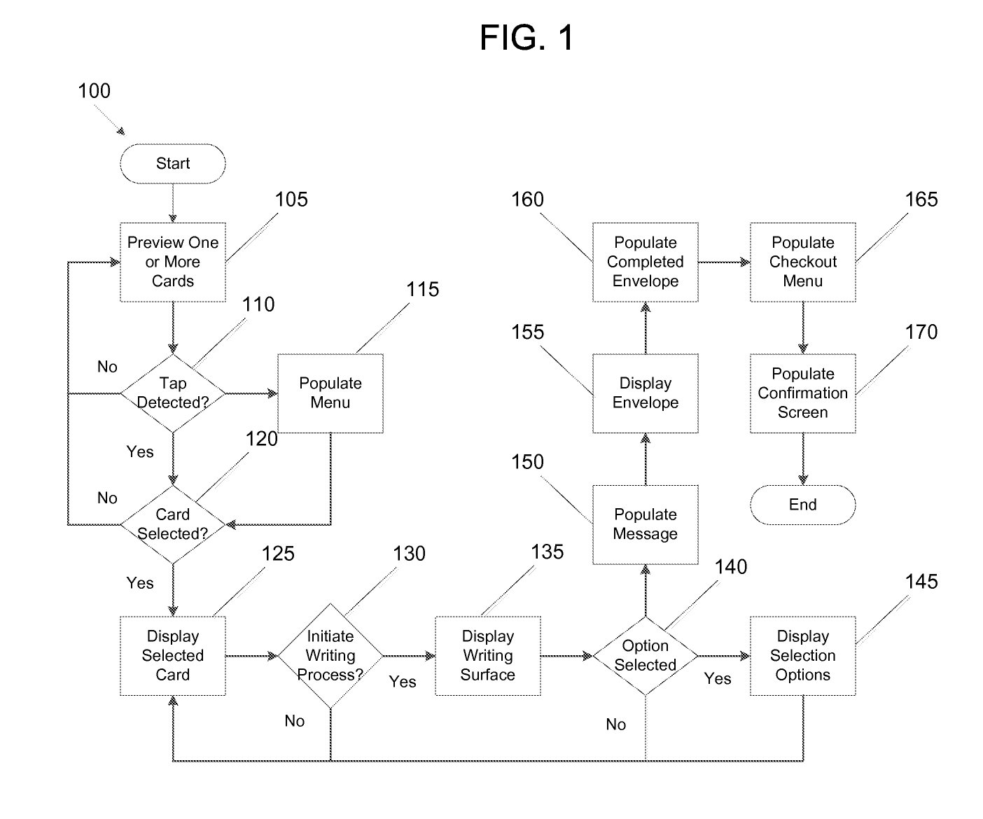

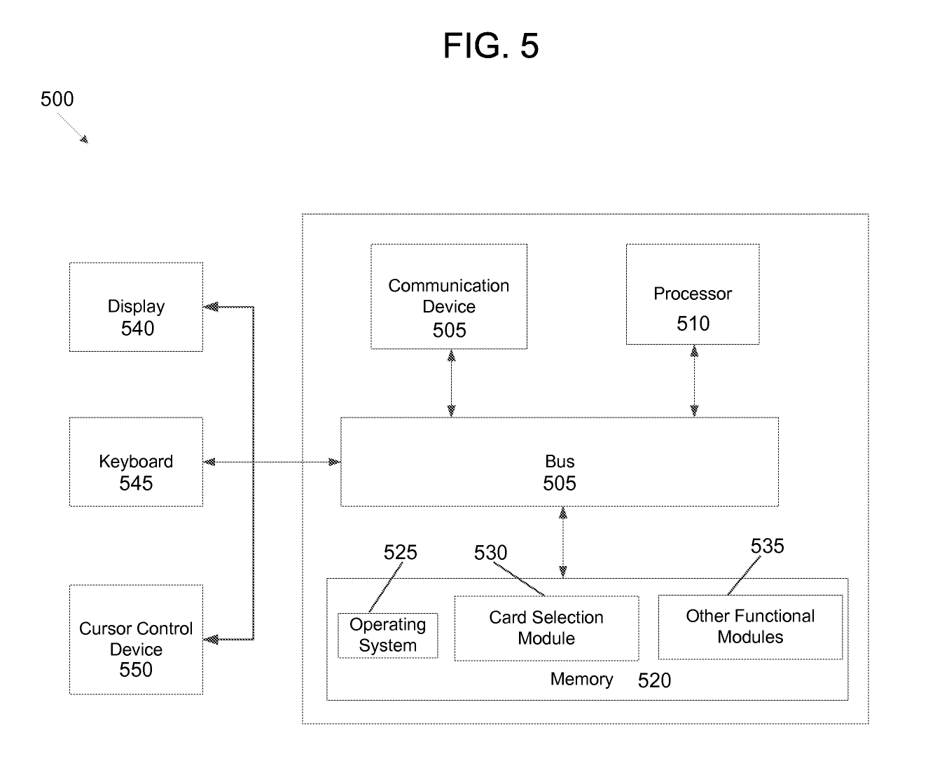

FIG. 1 is a flow diagram 100 illustrating a process for selecting and creating sentimental greeting cards and other types of novelty cards, according to an embodiment of the present application. The process of FIG. 1 may be executed by the application module 530 of FIG. 5, for example. The process may begin at 105 with the computing device allowing a user to view or preview one or more cards on a display of the computing device, such as a mobile computing device, laptop, smartphone, tablet computing device (i.e., iPad®), as the user swipes his or her finger across the display of the computing device. This functionality and corresponding user interface may be known as the “card wheel screen.” The card wheel screen may display images of one or more cards and may allow the user to use his or her finger to browse through the one or more cards. The first card begins at a first position and the user may swipe his or her finger to the right, for example, to browse until the n^{th} position. It should be noted that, depending on the configuration of the application, the user may swipe his or her finger in any direction to browse through the one or more cards. Each card that is displayed may have a background shadow image behind it, and a selected card may have a grey image that appears when the user has selected the card.

At 110, if the computing device detects that the user has tapped, for example, his or her finger on the display of the computing device, the computing device may populate a menu on the display. The menu may be a floating menu with selection buttons such as, user login frequently asked questions (FAQ), email, introduction, etc. The user login button, when selected allows the user to login to, or logout of, his or her account. The FAQ button, when selected provides the user with a list of questions and answers to the questions in order to answer any questions the user may have. The email button, when selected, opens an email to enable the user to contact and transmit a message to the company's help desk to troubleshoot any issues or ask any questions. The introduction button, when selected, provides general information about the company.

At 115, the computing device may detect whether a card has been selected and, if selected, the card may be displayed at 120 for a preview or customization. It should be appreciated that the user may be provided with the option to write on the inside of the card during the preview. The option to write on the card may be initiated when the user taps on the interior of the card displayed on the screen. The term write, herein, refers to handwriting, free-form doodling, drawing and the like.

In one embodiment, the first time the user views the preview screen, the computing device may populate a graphic that shows “tap to write.” This may instruct the user to tap on the screen so that the user can be taken to a writing screen. For example, at 125, the computing device may determine whether the user has initiated the writing process. If the computing device determines that the user has initiated the writing process, the computing device at 130 displays a zoomed view of the writing surface of the card. This allows the user to use his or her finger, or a stylus (or any type of tablet pen or instrument), to write on the card. Any use of any of these terms herein, as well as voice or gesture input, should denote any of these input mechanisms.

It should be noted that depending on the computing device, the user may use his or her finger to write on the card or use a keyboard to write on the card. For example, users of the first generation of iPad® may use the native background while users of the second generation of iPad® may use the card background to write.

It should be appreciated that a tool palette may also appear on the side of the display screen to allow the user to select a color, select a pen type, select an eraser, clear the entire writing surface, or access his or her library. For example, at 135, the computing device may determine that an option from the tool palette is selected and, at 140, provide the user with the appropriate selection options based on the option that was selected. Once the user selects from one of the selection option, the computing device at 145 displays the card writing screen.

For example, if the user selects the color button, then the computing device provides the user with the colors to select from. For example, the user may select from the following colors: blue, red, or black. Once the color is selected, the computing device may return to the card writing screen. In another embodiment, if the user selects the pen type button, the computing device provides the user the option to select a regular felt tip pen or a skinnier felt tip pen. Once the pen type is selected, the computing device may return to the card writing screen. If the clear writing surface button is selected, the computing device may clear the entire writing surface so the user can re-write his or her message. The computing device may confirm with the user that he or she wants to clear the writing surface.

If, for example, the computing device determines whether the user has selected the library from the tool palette, the computing device may provide pre-populated cards. For example, if a user has previously created an account and has previously sent cards, the previously sent cards may be automatically saved to the library. By accessing the library, the user can navigate through the previously created/sent cards. To navigate, the user may, for example, swipe his or her finger across the display.

If a user selects a previously sent card or selects a reuse button for the previously sent card, the computing device can populate and display the template card or previously sent card for the user. It should be noted that, in some embodiments, the previously sent cards could be deleted from the library if the user selects the previously sent card and selects the trash button.

Once one of the template cards, or one of the previously sent cards, has been selected, the computing device at 150 may populate the message into the writing surface such that the user can accept the populated message or modify the message. When the user selects the zoom out button on the preview screen, the computing device at 155 displays an envelope preview screen.

Similar to the card writing screen, the envelope preview screen includes a tool palette that allows the user to select a color button, a type of pen button, an eraser button to erase all or a portion of the message, a clear message button, or a library button. The library functionality may be similar to the library functionality from the card writing screen. Also similar to the card writing screen, the user may select the zoom out button so the computing device can populate at 160 a completed envelope screen.

At 165, once the user the user has completed the mailing and return address fields, the user can select the checkout button so the computing device can populate the checkout menu. If the fields are not completed, the computing device may alert the user that the fields are not filled out completely. The checkout menu includes the billing address and the delivery address. The user may have the ability to save the billing address for later use. When completely filled out, the user may select the checkout button. When the checkout button has been selected, the computing device at 170 may populate a confirmation screen that displays confirmation information and provides the user with the option to write a new card, or logout or exit.

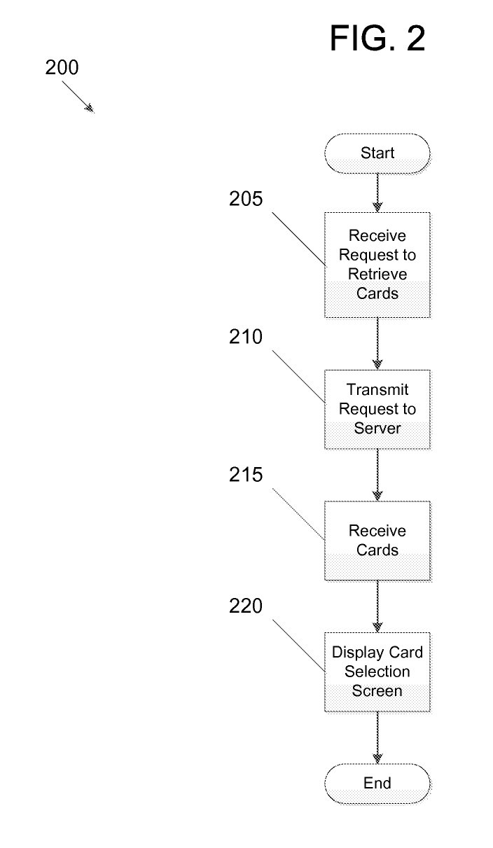

FIG. 2 is a flow diagram 200 illustrating a process for displaying one or more cards, according to one embodiment of the present application. The process of FIG. 2 may be executed by the application module 530 of FIG. 5, for example. For example, the process of FIG. 2 may begin at 205 with a computing system receiving a request for one or more cards. The request may indicate that the user desires to view one or more cards prior to customizing and purchasing the card. At 210, the computing system transmits a request for the one or more cards to a server, including a database storing the one or more cards, and, at 215, receives the one or more cards from the server. At 220, the one or more cards are displayed for preview on a card selection screen of the device of the user. The device may be a portable phone, a portable computing device, etc.

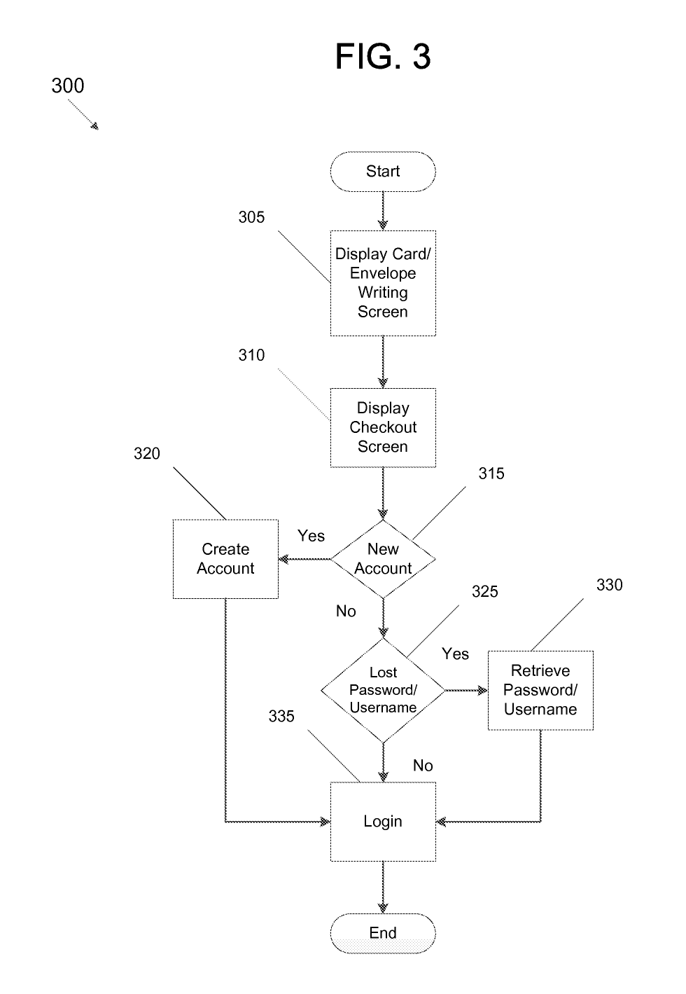

FIG. 3 is a flow diagram illustrating a process for checking out a card, according to one embodiment of the present application. The process of FIG. 3 may be executed by the application module 530 of FIG. 5, for example. For instance, the process of FIG. 3 may begin at 305 with a card/envelope selection screen being displayed to the user. This screen may allow the user to modify or customize the card that was selected, as well as modify or customize the envelope. Once the completed card/envelope modifications are complete, the computing device at 310 displays or populates a checkout screen. The computing device at 315 determines whether the user has an account established. If the user does not have an account, the computing device at 320 enables the user to create the account. Once created, the computing device at 335 logs the user into his or her account.

If the user has an account, but the computing device determines at 325 that the user has lost his username or password, the computing device at 330 enables the user to retrieve his or her username or password in order to login to the account at 335.

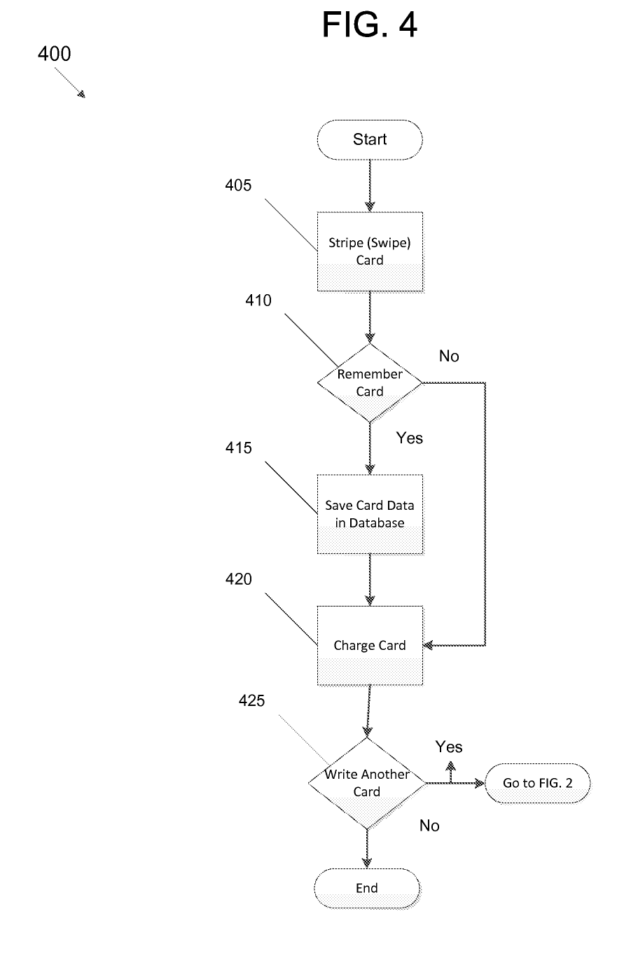

FIG. 4 illustrates a flow diagram 400 of a process for completing the order, according to one embodiment of the present application. The process of FIG. 4 may be executed by the application module 530 of FIG. 5, for example. The process may begin at 405 with the user swiping (or striping) his or her credit (or debit) card using the computing device. At 410, the user is asked whether he or she wants to save his or her credit card in a database. If the user selects to save his or her credit card, the computing device at 415 saves the credit card data on a database in a server.

At 420, regardless of whether the user saved his or her credit card to the database, the computing device charges the credit card. At 425, the computing device determines whether the user wishes to create or modify another card. If the user wishes to create or modify another card, the process returns to FIG. 2. If not, the process is completed.

The steps shown in FIGS. 1-4 may be performed, in part, by a computer program, encoding instructions for a nonlinear adaptive processor to cause at least the processes described in FIGS. 1-4 to be performed by the apparatuses discussed herein. The computer program may be embodied on a non-transitory computer readable medium. The computer readable medium may be, but is not limited to, a hard disk drive, a flash device, a random access memory, a tape, or any other such medium used to store data. The computer program may include encoded instructions for controlling the nonlinear adaptive processor to implement the processes described in FIGS. 1-4, which may also be stored on the computer readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, or an application specific integrated circuit (“ASIC”).

FIG. 5 is a block diagram illustrating a card selection system 300, according to an embodiment of the present application. Card selection system 500 may include a bus 505 or other communication mechanism that can communicate information and a processor 510, coupled to bus 505, that can process information. Processor 510 can be any type of general or specific purpose processor. System 500 may also include memory 520 that can store information and instructions to be executed by processor 510. Memory 520 can be comprised of any combination of random access memory (“RAM”), read only memory (“ROM”), static storage such as a magnetic or optical disk, or any other type of computer readable medium. Card selection system 500 may also include a communication device 515, such as a network interface card, that may provide access to a network.

The computer readable medium may be any available media that can be accessed by processor 510. The computer readable medium may include both volatile and nonvolatile medium, removable and non-removable media, and communication media. The communication media may include computer readable instructions, data structures, program modules, or other data and may include any information delivery media.

Processor 510 can also be coupled via bus 505 to a display 540, such as a Liquid Crystal Display (“LCD”). Display 540 may display information to the user, such as one or more cards for selection. A keyboard 545 and a cursor control unit 550, such as a computer mouse, may also be coupled to bus 505 to enable the user to interface with card selection system 500.

Numerous alternate embodiments include: a kiosk utilizing the instant application and printing a card that an individual could physically remove. Writing, drawing or inputting any word and/or shape can be placed on any part of the card (front, back and/or middle). Pictures, photos, drawings and the like can be added to the card, printed on the card, and/or inserted as a separate piece of paper or medium into the card. Addresses can be saved for future use when mailing the cards. A framework, including for example, solid and dotted lines can be provided to teach children how to write in cursive while writing on the card. Further, a message can be typed and then seen in cursive for purposes of tracing the cursive letters with a stylus and/or writing the cursive message utilizing the framework. Any input can be saved and can be posted to a website. Any input can be sent to a server which can confirm the identity the inputter by matching the content of a previously written card and/or the handwriting characteristics of a previously written card. Other options may permit selecting a professional handwriter to handwrite a card and/or address, previewing the input utilizing a number of different fonts, colors, including letter types (such as block, calligraphy, and the like) and accessing one of those previews for a final version of the card, providing an input to be used on a plurality of cards and adding a personalized message on one or more of the plurality of cards. For example, sending a plurality of holiday cards with a common message for all, as well as a personalized message for each recipient. Changing the look and feel, as well as the word or shape or any input on the card may be performed by selecting that portion. Color of any input can be changed based on a portion of the card where the input is being received, the contents that is being input, or the instrument being used. A color can be chosen by accessing a palette via a typical action or can be performed as described. Objects and other inputs can be traced with an instrument for inclusion into the card. Additional options may include providing an integrated card-worthy events calendar for all or some of a user's contacts, providing a digital handwritten-but-searchable address book, inserting a picture of a handwritten message that has been photographed on any portion of the card.

According to one embodiment, memory 520 may store software modules that may provide functionality when executed by processor 510. The modules can include an operating system 525 and a card selection module 530, as well as other functional modules 535. Operating system 525 may provide operating system functionality for card selection system 500. Because card selection system 500 may be part of a larger system, card selection system 500 may include one or more additional functional modules 535 to include the additional functionality.

One skilled in the art will appreciate that a “system” could be embodied as a personal computer, a server, a console, a personal digital assistant (PDA), a cell phone, a tablet computing device, or any other suitable computing device, or combination of devices. Presenting the above-described functions as being performed by a “system” is not intended to limit the scope of the present application in any way, but is intended to provide one example of many embodiments of the present application. Indeed, methods, systems and apparatuses disclosed herein may be implemented in localized and distributed forms consistent with computing technology.

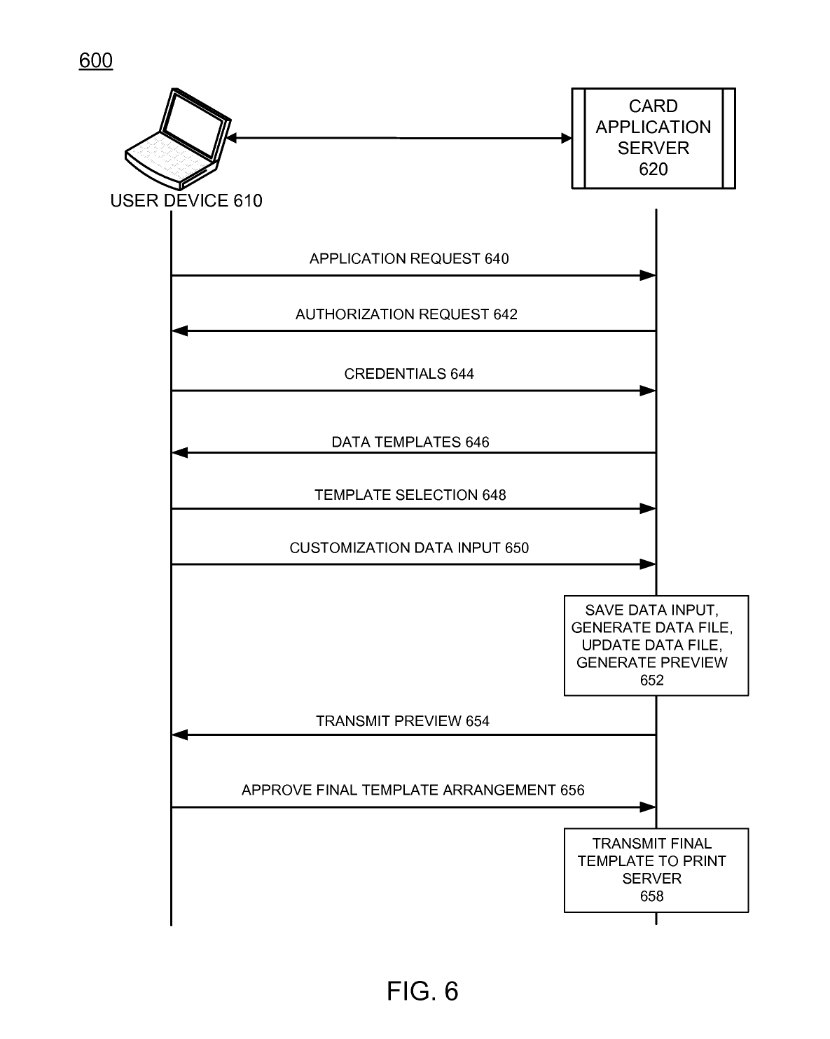

According to another example, the card creation process may be initiated by a user device 610 communicating with the card application server 620 in the signaling diagram 600 of FIG. 6. One example procedure may include accessing the card creation application and submitting a request 640 to initiate the newest and most updated selection of data templates or specifically greeting card templates. The request may be authorized based on user credentials, such as a device ID, a user ID, password, login, etc., and an authorization request may be sent to the user including a login interface if necessary at operation 642. The user may submit the necessary credentials 644 to receive a set of data templates 646 that are most updated or based on the user's interests. The user may access, browse and identify a particular template of interest and confirm the selection to the server 648. The application may then place the data template of interest into an editing format so the user may setup one or more customization options to be included on the card. The customization data input 650 may include a handwritten message stored in an image file that is used to populate a predefined area of the card. The application server 620 may save the data as a data file type and update the data as it changes based on the user input data received. Once a template is complete, the user may request a preview or the application may automatically generate a preview 652 to demonstrate how the card would look based on the customization options presented from the user's data input. The preview may be transmitted 654 to the user computing device. A final template arrangement 656 may be approved and saved in the application server 620. The final template may be transmitted to a print server so a hard copy of the card may be generated 658.

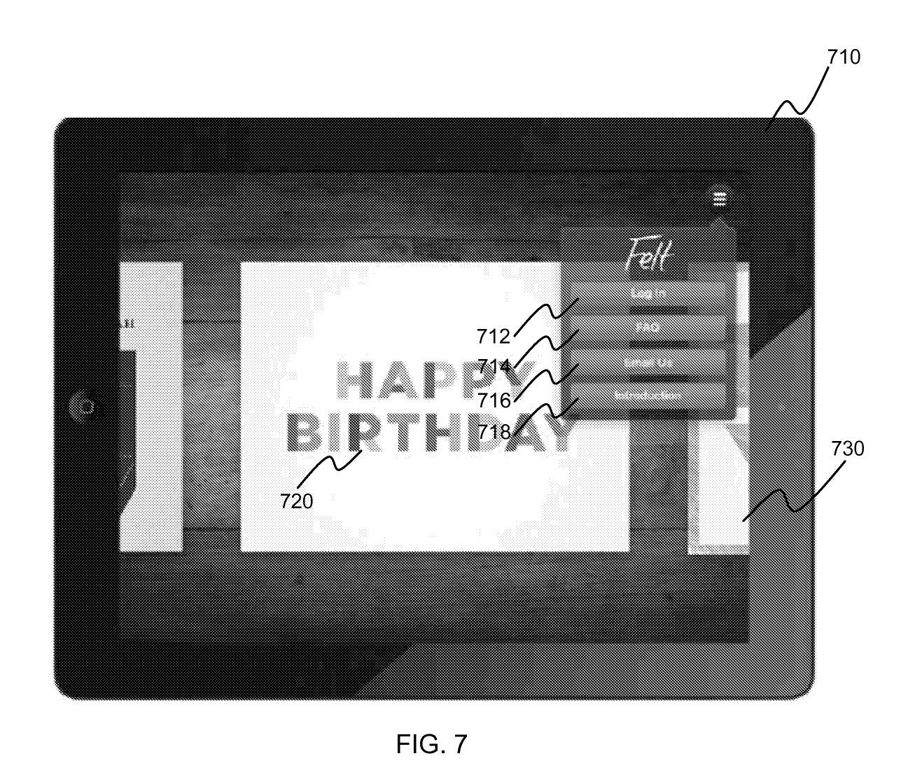

FIG. 7 illustrates an example screen shot of a user interface of the card generation application according to an embodiment of the present application. Referring to FIG. 7, the computing device 710 includes a display that is demonstrating the user interface for selecting a card template and editing the card. The user may browse various templates 730 by selecting the scrolling function on the touch screen display. The present example 720 is a happy birthday card that when selected includes an editing menu to login 712, ask questions 714, email the administrator 716 or receive information 718. The user may quickly access the live editing options, save the customization efforts and receive a final print out of their card by mail or by computer data file. For example, the card may be printed in hard copy or imported into a friendly welcome, party, celebration, sentimental email with other aesthetic content so the card can be clicked and opened electronically to reveal the customized user submitted content, its overlay with the digital card format of the template and any other user customized data.

In addition, the card may be forwarded directly to a user's social networking profile or a recipient user's social networking profile. A user may finish the content to be published to the card and may submit the card to a social networking platform associated with a designated user account via a third party application of via the social networking application. The user may then login or access the social networking site (such as FACEBOOK®, for example) and identify a user or group of users as potential recipients. The user may then forward the card to the recipient(s) as a proprietary application message specific to the social networking site. The recipient(s) may then receive the card as a digital message and open the card within the social networking application via a computer selection operation.

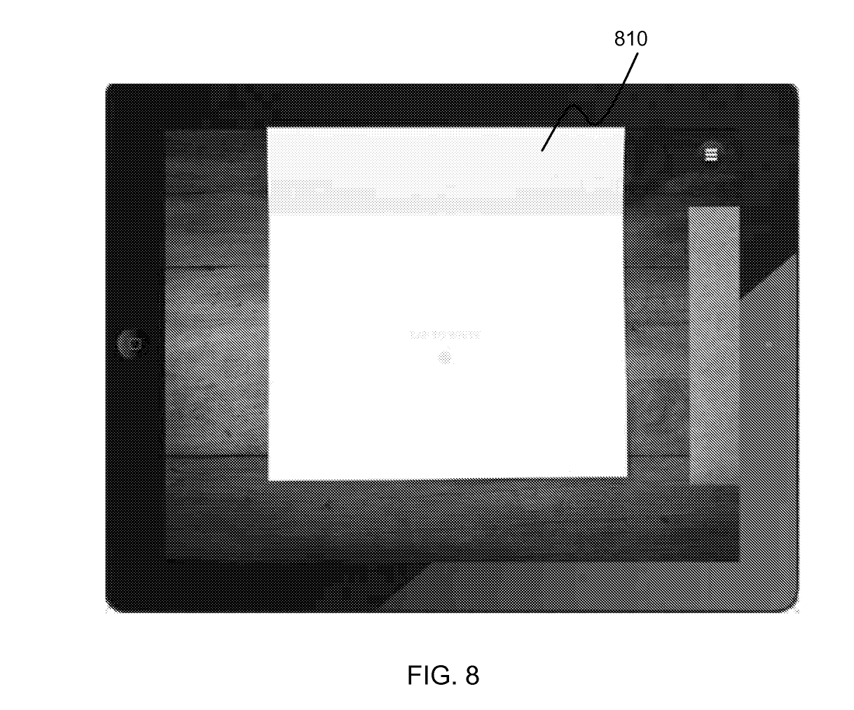

FIG. 8 illustrates another example screen shot of a user interface of the card generation application according to an embodiment of the present application. Referring to FIG. 8, the user may initiate a blank editing function to populate a blank card via its predefined data insert area 810. For instance, the inside of the card may be automatically presented to the user when they request access to the template and they user may then type, write by finger or stylus device and provide input to the card.

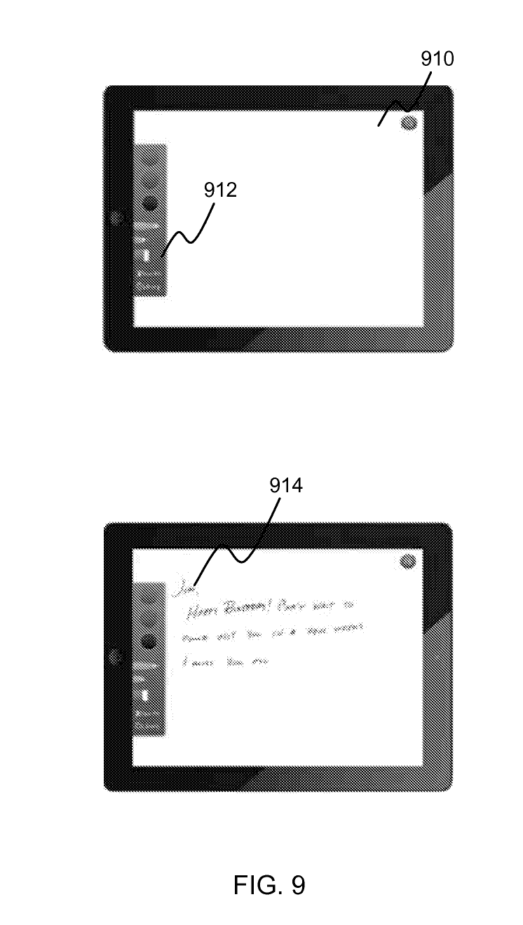

FIG. 9 illustrates example screen shots of a user interface for data input of the card generation application according to an embodiment of the present application. Referring to FIG. 9, the blank space 910 may be populated with content based on various input methods 912, such as a virtual pen, pencil, color, brush stroke, type format, etc. Once the user writes a message, the image data may be saved in the card template 914 automatically or per the user's request.

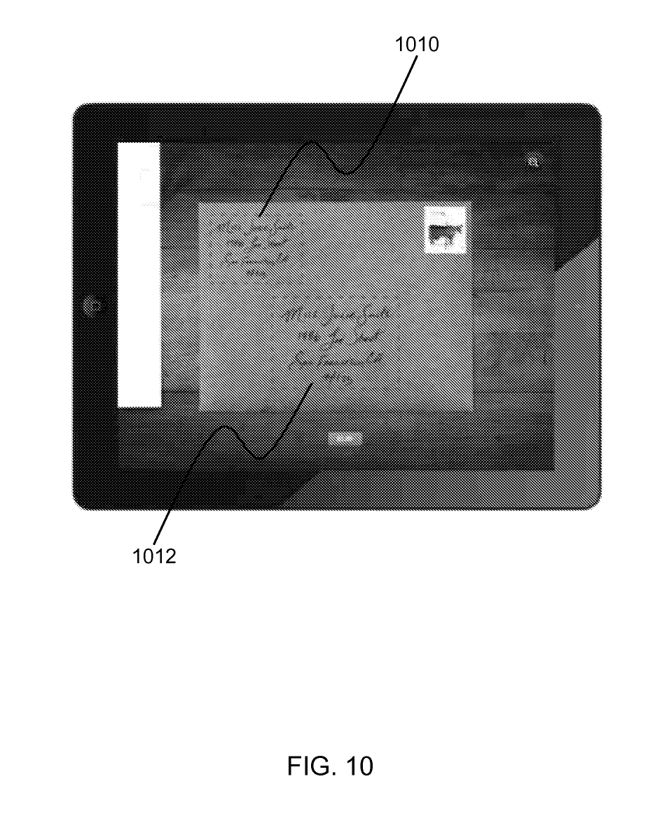

FIG. 10 illustrates an example screen shot of a user interface for data overlay of the card generation application according to an embodiment of the present application. Referring to FIG. 10, the card may be edited by including a customization of the envelope. In this example, the user may type or draw the forwarding address 1012 and/or return address 1010 by hand to increase the customization functions of the card creation process.

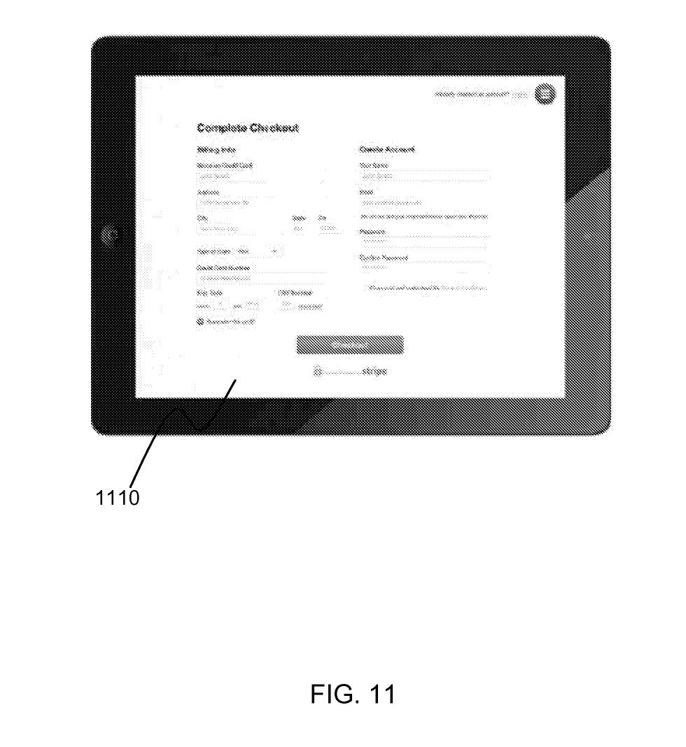

FIG. 11 illustrates another example screen shot of a user interface for finalizing a card of the card application according to an embodiment of the present application. In FIG. 11, the user interface 1110 may provide the user with the option to login, pay, create an account, create frequency options (send this out every year, etc.) and customize the user account settings for previously submitted, contemporaneous and subsequent card creating efforts.

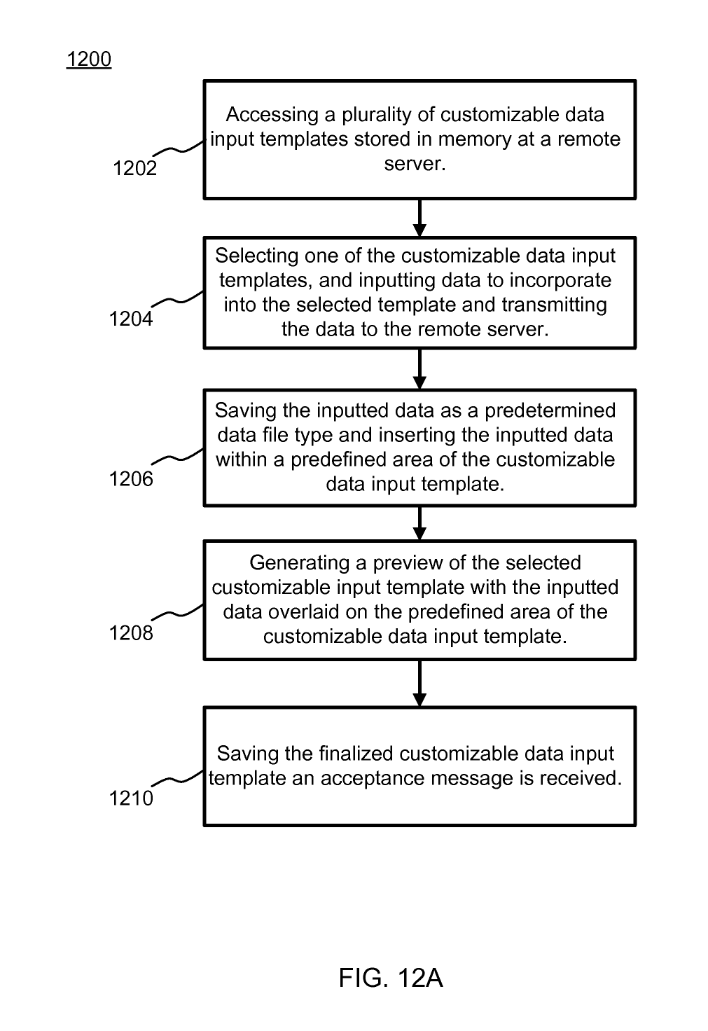

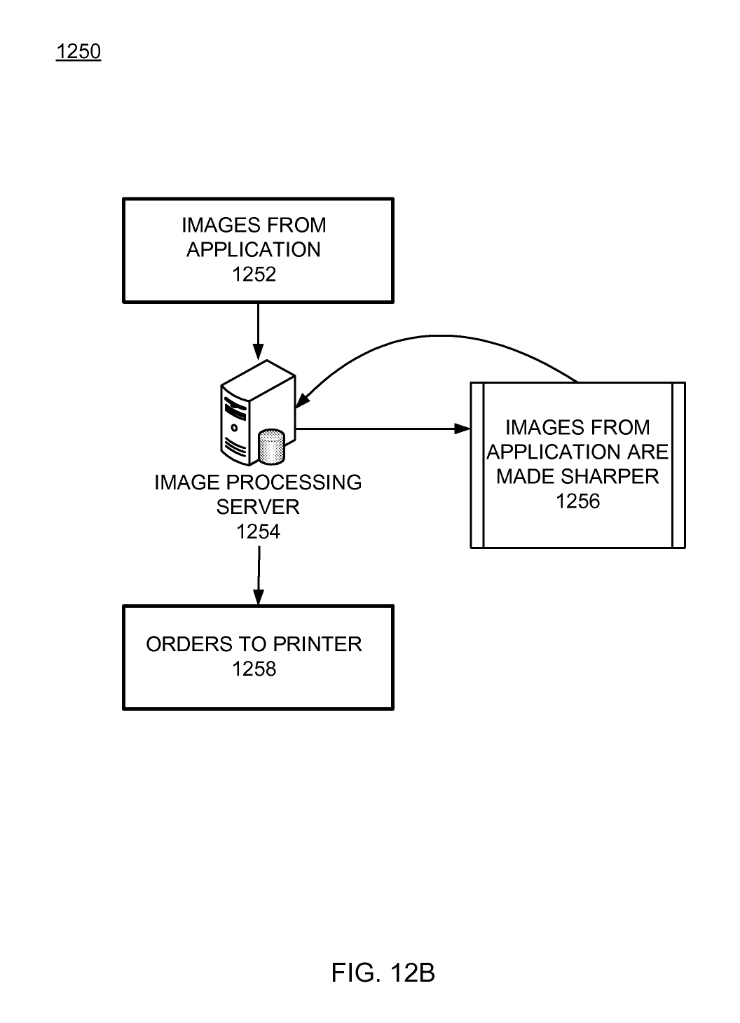

FIG. 12A illustrates a flow diagram of an example method of operation according to an embodiment of the present application. Referring to FIG. 12A, accessing a plurality of customizable data input templates stored in memory at a remote server at operation 1202 and selecting one of the plurality of customizable data input templates, inputting data to incorporate into the selected customizable data input template, and transmitting the data to the remote server at operation 1204. The method may also include saving the inputted data as a predetermined data file type and inserting the inputted data within a predefined area of the customizable data input template, at operation 1206, and generating a preview of the selected customizable input template with the inputted data overlaid on the predefined area of the customizable data input template, the preview permitting an acceptance option to finalize or reject the customizable data input template at operation 1208. The method may also include saving the finalized customizable data input template an acceptance message is received at operation 1210. For instance, the user's input or writing may be saved as a specific file format type (e.g., *.PNG image) with a transparent background. Then this image is placed in the *.PDF style template for printing purposes. This may be the same process for both the cards and envelopes used with the cards. The overlaid writings may be combined with the card template prior to finalizing the card format.

FIG. 12B illustrates a logic diagram of an example method of operation according to an embodiment of the present application. Referring to FIG. 12B, the logic diagram 1250 provides for an example where the images created and associated with the application card creation process are adjusted and modified prior to finalization efforts. For instance, the images from the application that are modified or selected may be identified as being associated with a particular data template or card. The image processing server 1254 may identify one or more image files as requiring some auto-correction or sharpening so the final image overlay on the card will be increasingly presentable or aesthetic for the end users. The images are identified, such as pictures, add-ons, drawings, shapes, backgrounds, hand-drawn words, signatures, etc., and are then processed to identify the image lines, contrast with the background and various sharpening algorithms may be applied 1256 to increase the visibility of the data. The images are then re-applied to the cards/templates and finalized in a file saving operation. The final products are shared with a printer or print server 1258 to finalize a hard copy print-out of the card.

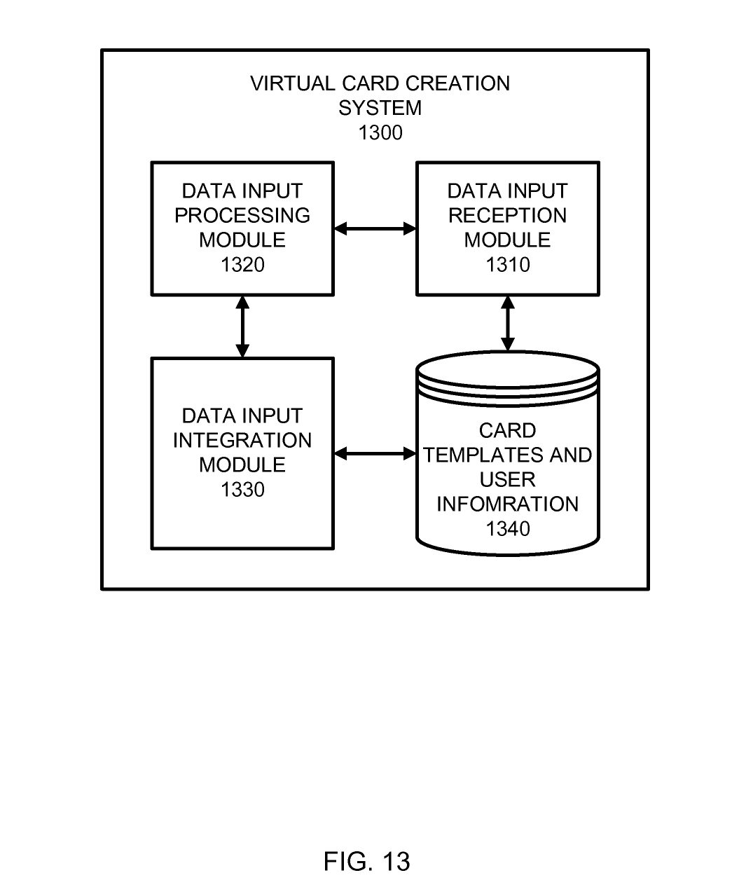

FIG. 13 illustrates an example system configured to perform an example method of operation according to an example embodiment. Referring to FIG. 13, a virtual card creation system 1300 may include a set of modules and a data memory storage as part of the same entity or multiple entities depending on the configuration and may perform transmitting, receiving, processing and storing of data.

In one example method of operation, the system may include accessing a number of customizable data input templates stored in memory at a remote server and selecting one of the customizable data input templates. Once a template of interest is identified, the data input reception module 1310 may receive a user input and incorporate the input into the template as a work in progress. The data inputted may be received and processed by the data input processing module 1320. The data may be saved as a predetermined data file type, such as an image or postscript data file type and inserted within a predefined area of the customizable data input template via the data input integration module 1330. The card templates, the user account information and the finalized or work-in-progress files associated with user accounts may be saved in the card templates and user information databank 1340. After the data file has been modified, a preview of the selected customizable input template may be generated with the inputted data overlaid on the predefined area of the customizable data input template. The preview may permit an acceptance option to finalize or reject the customizable data input template. The user may accept the preview as a suitable result and the system may save the finalized customizable data input template if the acceptance message is received.

According to other example operations, the inputted data may be periodically transmitted to the remote server as the inputted data changes from a previously logged inputted data segment to an updated input data segment that includes any changes since the previously logged inputted data segment. Periodic file saving operations may occur or may occur responsive to a certain amount of changes being identified to the data template. The data file may be overwritten to include the updated input data segment and saved. The updated data file may be associated with the finalized content of the data input template responsive to receiving an acceptance message that the data input template is complete. The predefined data file type may be an image file, a postscript data file format or other file format.

The customizable data templates are virtual greeting cards used to print a hard copy greeting card, and the inputting data process may include generating image data from a touch pad sensor array of a computing device. The updated data file may be saved as a new card, and added to a user account of previously stored cards in the remote server. The customizable data templates may be a virtual greeting card, virtual office stationary forms, and virtual invitations. The image data generated from the user may be input from a touch pad sensor array of a computing device (e.g., smartphone touch screen) and a gesture input detector of the computing device (e.g., touchless sensor configuration).

After the written images from the application are uploaded to the server, a process may be executed on the images which “sharpens” to look better written and less printed. Also, the images are converted from the more well known red, green, blue format (RGB) to CMYK and the “black” items are made “true black” to avoid a red hue being printed around the written letters.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

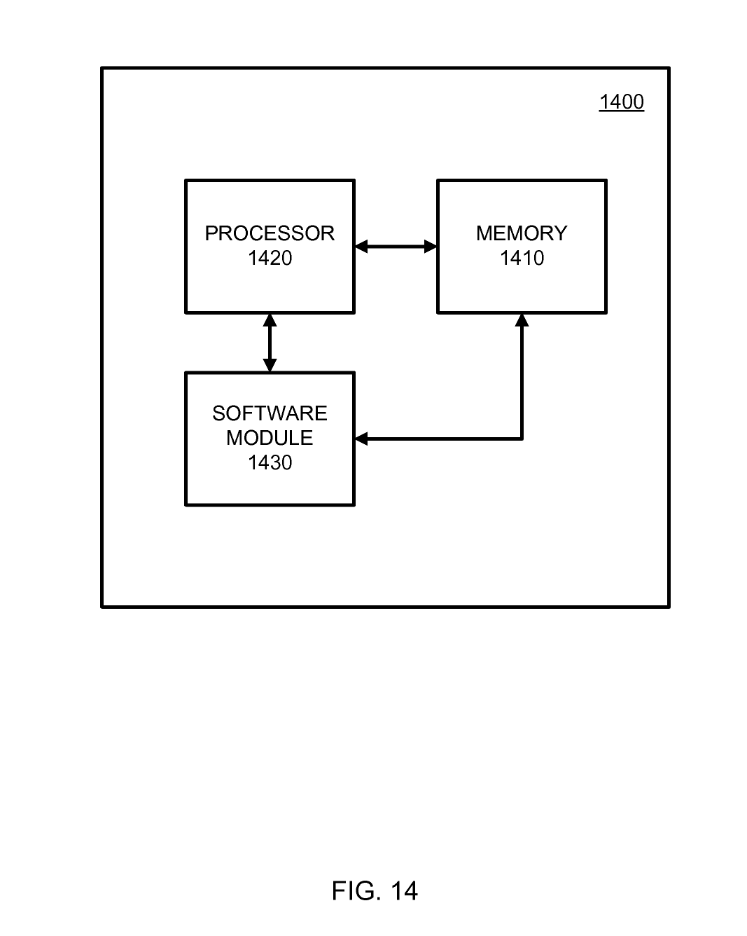

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example FIG. 14 illustrates an example network element 1400, which may represent any of the above-described network components, etc.

As illustrated in FIG. 14, a memory 1410 and a processor 1420 may be discrete components of the network entity 1400 that are used to execute an application or set of operations. The application may be coded in software in a computer language understood by the processor 1420, and stored in a computer readable medium, such as, the memory 1410. The computer readable medium may be a non-transitory computer readable medium that includes tangible hardware components in addition to software stored in memory. Furthermore, a software module 1430 may be another discrete entity that is part of the network entity 1400, and which contains software instructions that may be executed by the processor 1420. In addition to the above noted components of the network entity 1400, the network entity 1400 may also have a transmitter and receiver pair configured to receive and transmit communication signals (not shown).

Although an exemplary embodiment of the system, method, and computer readable medium of the present application has been illustrated in the accompanied drawings and described in the foregoing detailed description, it will be understood that the application is not limited to the embodiments disclosed, but is capable of numerous rearrangements, modifications, and substitutions without departing from the spirit or scope of the application as set forth and defined by the following claims. For example, the capabilities of the system of FIG. 5 can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way, but is intended to provide one example of many embodiments of the present application. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed, but is merely representative of selected embodiments of the application.

One having ordinary skill in the art will readily understand that the application as discussed above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent, while remaining within the spirit and scope of the application. In order to determine the metes and bounds of the application, therefore, reference should be made to the appended claims.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method comprising:
accessing a plurality of customizable data input templates stored in memory at a remote server;
selecting one of the plurality of customizable data input templates;
inputting data to incorporate into the selected customizable data input template;
transmitting the data to the remote server;
saving the inputted data as a predetermined data file type and inserting the inputted data within a predefined area of the customizable data input template;
generating a preview of the selected customizable input template with the inputted data overlaid on the predefined area of the customizable data input template, the preview permitting an acceptance option to finalize or reject the customizable data input template; and
saving the finalized customizable data input template an acceptance message is received.

2. The method of claim 1, further comprising:
periodically transmitting the inputted data to the remote server as the inputted data changes from a previously logged inputted data segment change to an updated input data segment that includes any changes since the previously logged inputted data segment;
overwriting a data file associated with the previously logged inputted data segment to include the updated input data segment; and
saving the overwritten data file as the updated data file.

3. The method of claim 2, further comprising:
applying the updated data file as finalized content of the data input template responsive to receiving an acceptance message that the data input template is complete.

4. The method of claim 1, wherein the predefined data file type is at least one of an image file and a postscript data file format.

5. The method of claim 1, wherein the customizable data templates are at least one of virtual greeting cards, virtual office stationary forms, and virtual invitations used to print a hard copy of at least one of greeting card, virtual office stationary forms, and virtual invitations.

6. The method of claim 1, wherein inputting data comprises generating image data from at least one of a touch pad sensor array of a computing device and a gesture input detector of the computing device.

7. The method of claim 2, further comprising:
saving the updated data file as a new card;
adding the new card to a user account of previously stored cards in the remote server;
determining whether to transmit the new card to a printer to generate a hard copy printout or to transmit the card to an e-mail generation application that imports the new card into an e-mail to be sent to at least one destination user device.

8. An apparatus comprising:
a processor configured to
access a plurality of customizable data input templates stored in memory at a remote server;
select one of the plurality of customizable data input templates;
input data to incorporate into the selected customizable data input template;
a transmitter configured to transmit the data to the remote server;
a memory configured to save the inputted data as a predetermined data file type, and
wherein the processor is further configured to insert the inputted data within a predefined area of the customizable data input template, and generate a preview of the selected customizable input template with the inputted data overlaid on the predefined area of the customizable data input template, the preview permitting an acceptance option to finalize or reject the customizable data input template, and save the finalized customizable data input template an acceptance message is received.

9. The apparatus of claim 8, wherein the processor is further configured to
periodically transmit the inputted data to the remote server as the inputted data changes from a previously logged inputted data segment change to an updated input data segment that includes any changes since the previously logged inputted data segment,
overwrite a data file associated with the previously logged inputted data segment to include the updated input data segment, and
save the overwritten data file as the updated data file.

10. The apparatus of claim 9, wherein the processor is further configured to apply the updated data file as finalized content of the data input template responsive to receiving an acceptance message that the data input template is complete.

11. The apparatus of claim 8, wherein the predefined data file type is at least one of an image file and a postscript data file format.

12. The apparatus of claim 8, wherein the customizable data templates are at least one of virtual greeting cards, virtual office stationary forms, and virtual invitations used to print a hard copy of at least one of greeting card, virtual office stationary forms, and virtual invitations.

13. The apparatus of claim 8, wherein inputting data comprises generating image data from at least one of a touch pad sensor array of a computing device and a gesture input detector of the computing device.

14. The apparatus of claim 8, wherein the processor is further configured to save the updated data file as a new card, and add the new card to a user account of previously stored cards in the remote server, and determine whether to transmit the new card to a printer to generate a hard copy printout or to transmit the card to an e-mail generation application that imports the new card into an e-mail to be sent to at least one destination user device.

15. A non-transitory computer readable storage medium configured to store instructions that when executed cause a processor to perform:
accessing a plurality of customizable data input templates stored in memory at a remote server;
selecting one of the plurality of customizable data input templates;
inputting data to incorporate into the selected customizable data input template;
transmitting the data to the remote server;
saving the inputted data as a predetermined data file type and inserting the inputted data within a predefined area of the customizable data input template;
generating a preview of the selected customizable input template with the inputted data overlaid on the predefined area of the customizable data input template, the preview permitting an acceptance option to finalize or reject the customizable data input template; and
saving the finalized customizable data input template an acceptance message is received.

16. The non-transitory computer readable storage medium of claim 15, wherein the processor is further configured to perform:
periodically transmitting the inputted data to the remote server as the inputted data changes from a previously logged inputted data segment change to an updated input data segment that includes any changes since the previously logged inputted data segment;
overwriting a data file associated with the previously logged inputted data segment to include the updated input data segment;
saving the overwritten data file as the updated data file saving the updated data file as a new card; and
adding the new card to a user account of previously stored cards in the remote server.

17. The non-transitory computer readable storage medium of claim 16, wherein the processor is further configured to perform:
applying the updated data file as finalized content of the data input template responsive to receiving an acceptance message that the data input template is complete.

18. The non-transitory computer readable storage medium of claim 15, wherein the predefined data file type is at least one of an image file and a postscript data file format.

19. The non-transitory computer readable storage medium of claim 15, wherein the customizable data templates are at least one of virtual greeting cards, virtual office stationary forms, and virtual invitations used to print a hard copy of at least one of greeting card, virtual office stationary forms, and virtual invitations.

20. The non-transitory computer readable storage medium of claim 15, wherein inputting data comprises generating image data from at least one of a touch pad sensor array of a computing device and a gesture input detector of the computing device.
